(19) United States
(12) Patent Application Publication
(10) Pub. No.: US 2007/0103928 A1
(43) Pub. Date: May 10, 2007

(54) AUTOMATED PROCESS FOR EMBEDDING OPTICAL FIBERS IN WOVEN COMPOSITES

(76) Inventors: Keith Goossen, Howell, NJ (US); Eric Dean Wetzel, Baltimore, MD (US); Richard P. Caruso, Northborough, MA (US)

Correspondence Address: Connolly Bove Lodge & Hutz LLP, P.O. Box 2207, Wilmington, DE, 19899-2207, US

(21) Appl. No.: 11/557,617

(22) Filed: Nov. 8, 2006

Related U.S. Application Data
(60) Provisional application No. 60/734,940, filed on Nov. 9, 2005.

(51) Int. Cl. G02B 6/04

(52) U.S. Cl. 362/556; 362/554

(57) ABSTRACT

An automated process for embedding optical fiber in woven composites includes embedding a woven fabric in resin using a vacuum infusion process to create a structural composite with integrated optical conduit with less than 0.8413 optical loss. The optical fiber is embedded in the woven fabric in both warp and weft directions. Optical fiber connectorization is done without polishing.

### CROSS REFERENCE TO RELATED APPLICATION

This application is based on provisional application Ser. No. 60/734,940, filed Nov. 9, 2005, all of the details of which are incorporated herein by reference thereto.

### GOVERNMENT LICENSE RIGHTS

The United States government has rights to this invention which was done under funding by Army Research Laboratory, grant DAAD 19-01-2-0001.

### BACKGROUND OF INVENTION

Composite materials composed of woven fabrics embedded in polymeric resin are finding increased usage in a variety of structural applications. Additionally their construction allows for embedding of optical fibers for sensing or communication. Until recently optical fibers have been embedded in composites manually or semi-automatically, which while useful for laboratory experiments is not appropriate for mass production.

### SUMMARY OF INVENTION

The present invention relates to a completely automated process for embedding optical fibers in woven fabrics in both warp and weft directions. These fabrics were embedded in resin using a vacuum infusion process, resulting in a structural composite with integrated optical conduit with less than 0.8413 optical loss. Conventional connectorization techniques for optical fibers require polishing steps which increase the labor, cost, and complexity associated with integrating waveguides into composite structures. A novel technique for connectorization of optical fibers is demonstrated which requires no polishing, short times, and simple tooling. The combination of automated optical fiber introduction and non-polishing connectorization should enable low-cost incorporation of optical buses into structural composites.

In general, the present invention relates to techniques for integrating optical fiber into composite structural materials for embedded sensors and communication links. Such structures where optical fibers exist embedded in structures, have existed previously. The present invention, however, relates to the method of introduction. In accordance with the invention the fiber can be introduced in an automated fashion into composite structural materials which have as one of their components a woven fabric. Such fabrics are akin to textiles and, in fact, the invention could be used where the fabrics are textiles. The invention could also be practiced where the fabrics are armor-related fabrics such as woven fiberglass. In such practice of the invention a spool of optical fiber can replace a spool of fiberglass in the weaving machinery. One aspect of the invention is the method of integrating optical fiber into woven materials in an automated fashion by replacing the spool of yarn by a spool of optical fiber in the weaving machine.

### THE DRAWINGS

FIG. 1 is a schematic showing of the VARTM setup used for fabrication the composite panel with integrated optical fiber;

FIG. 2 is a schematic showing of the optical yarn fabrication process;

FIG. 3 is a schematic showing of the direct optical fiber fabrication process;

FIG. 4 is a graph showing the optical loss in weft direction for optical yarn fabric;

FIGS. 5(a) and (b) show the optical loss in the warp and weft directions for direct optical fiber;

FIG. 6 is a bar graph showing weft-direction optical loss in composite with direct optical fabric perform; and

FIG. 7 is a bar graph showing the optical loss in optical fibers in metal ferrules, and cut using either scissors or cutting pliers.

### DETAILED DESCRIPTION

1. Introduction

Two application areas necessitate embedding optical fibers into structural fiber-reinforced polymer composites: sensing and communication. For sensing applications, optical sensors provide a compact, low-power means for transducing properties such as temperature, strain, and degree of cure. This information, in turn, can then be used to judge the health of a structure, interrogate the conditions of the surrounding environment, or monitor and adjust the process conditions during fabrication of the composite [1-9]. By coupling many optical fiber sensors into a distributed sensor network, a rich data set is generated which can be used to assess the global conditions of a composite structure.

For communication applications, the optical fiber acts as a conduit which transmits data between points on the structure. By necessity, optical sensors include fiber optic leads which allow communication between the sensor and the optical conditioning source. In simpler communication applications, information is transmitted into the composite structure, shuttled along the composite to another location, and then transmitted out of the composite and into a receiver. These integral communication conduits can replace conventional data conduits, such as metallic wiring and optical cabling, on conventional composite structures such as air and ground vehicles, ships, spacecraft, and civil structures. Embedding the optical fiber into the structure provides a number of advantages, such as lower weight, more compact packaging, manufacturing simplicity through simplification of wire routing, and the creation of robust networks through redundant optical pathways.

The optical data networks required for structural composites offer two characteristics which make their implementation different than the design of conventional communication networks. First, the typical transmission length is only tens of meters, rather than the hundreds of kilometers which can be traversed by traditional optical networks. These shorter distances permit higher linear signal loss, which allows for the use of lossier conduit materials (such as plastic optical fibers) and transceiver technologies. Secondly, for most structural composite applications, the required data bandwidth is relatively low. These lower bandwidth applications allow for the use of simpler and slower data encoding and transceiving methods than would be acceptable in traditional telecommunications.

A number of methods for embedding optical fibers into structural composites have already been demonstrated. The simplest and perhaps most common approach is to simply place the optical fiber between layers of preform or prepreg, physically isolating the ends (such as extending the fiber ends well beyond the nominal part dimension), and then processing the preform or prepreg into a composite through conventional means. This approach is labor intensive, inconsistent, and difficult to scale to manufacturing settings. Schuster et al. [10] demonstrate the semi-automatic incorporation of optical fibers into a woven fabric, using a lab-scale fabric weaver. The weaver is computer controlled, but requires operator intervention to switch between optical fibers and structural yarns during the weaving process. Furthermore, the size, speed, and cover factor for the fabric production process were significantly less than commercial weaving operations. Bogdanovich et at [II] have demonstrated an automated approach for producing 3d-woven preforms with incorporated optical fibers. However, these preforms are not of the traditional plain-woven architecture, and instead consist of unidirectional plies stitched together into 0/90 orientations. The minimal crimp in these fabrics significantly simplifies optical fiber handling during weaving.

The present invention relates to various automated, scalable methods for incorporation of optical fibers into traditional woven glass fabrics. The fabrics are produced using commercial looms, at rates and sizes comparable to industrial fabric preduction. These preforms are then incorporated into vacuum-processed composites, with optical loss characterized for both weft- and warp-direction optical fibers. Additionally, a novel non-polishing technique for connectorization of the optical fibers is proposed which is simple and low cost, but produces acceptable levels of optical coupling.

2. Materials and Methods

2.1 Optical Fiber

The Infiniband™ Coming (Coming, N.Y.) multimode optical fibers used in this work consist of a 125 μm glass optical fiber with a 62.5 gm core. A protective acrylate coating brings the total fiber diameter to 250 gin.

2.2 Structural Glass Fiber

Both B-glass and S-glass structural glass fibers were used in this study. B-glass fibers consist of alumina-calcium borosilicate glasses, and are used as general purpose fibers where strength and high electrical resistivity are required. S-glass consists of magnesium aluminosilicate glasses and, although more expensive, offer higher strength, stiffness, thermal stability, and chemical resistance than B-glass fibers.

2.3 Optical Connectivity Measurements

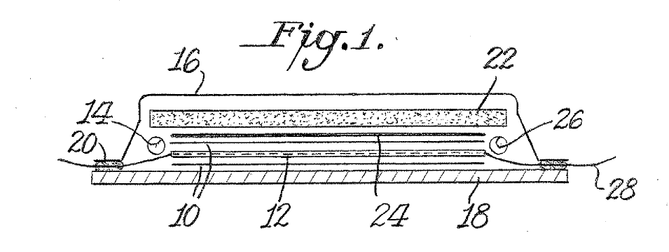

For all preform and composite fiber optic connectorizations, non-polishing connectors from L-Com (North Andover, Mass.) as shown in FIG. 1 were used. To connectorize, the plastic coating on the optical fiber was removed using a flame, followed by cleaning the bare optical fiber with alcohol wipes and cleaving the end to obtain a perfect flat cut. The fiber was then inserted into the connector, which contains a ferrule that has a polished optical fiber built into it. A clamping mechanism built into the connector ensures good mating of the optical fiber with the internal ferrule.

Optical loss measurements were made using a commercial fiber optic test kit manufactured by Promax, consisting of a transmitting laser and a detector unit that measures power in dBm (10log₁₀[P(mW)]). Optical losses were referenced to the loss of a precision optical fiber jumper that was made using polished connectors. For all experiments the system used a light wavelength of 1.3 p.m.

2.4. Composite Panel Fabrication

Vacuum-assisted resin transfer molding (VARTM) [12] was used to fabricate the composite specimens. FIG. 1 shows the schematics of VARTM process. The preform consisted of 3 layers of fabric: two outer layers 10,10 of conventional, 0.8 14 kg/M² B-glass fabric, and a single ply of glass fabric 12 with integrated optical fibers as the center layer. The preform dimensions were 500 mm×400 mm. Resin was infused through inlet 14 into the part using vacuum pressure, with a distribution layer used to enable wet-out of the full preform. The optical fibers were connectorized prior to resin infusion, with the ends of the optical fibers outside of the vacuum bag during infusion and cure. Derakane 411-350 epoxy vinyl ester resin was used and it was allowed to cure at room temperature for 5 hours. The final part thickness was 5 mm.

FIG. 1 illustrates the bagging film 16 mounted by means of sealing tape 20 to base plate 18 having release coating. The distribution media 22 is shown as being above porous release film 24 which is disposed above one of the outer layers 10. FIG. 1 also illustrates the resin outlet 26 leading to the vacuum source and shows the optical fiber 28.

3. Embedding Optical Fiber into Fabric Preforms

Two methods were investigated for incorporation of optical fiber into woven preforms. In the first case, a single optical fiber was first co-mingled with a multi-ended roving, and then this roving was used as a yarn in a conventional fabric weaving process. In the second case, optical fiber was commingled with the structural yarn during the actual weaving process.

Plain woven fabrics are constructed by pulling parallel yarns from individual spools along the longitudinal, or “warp” direction. Alternating warp yarns are raised and lowered to create a space called the “shed” through which the transverse, or “weft”, yarns are inserted. The most common method of weft yarn insertion in commercial looms uses fixed spools, outside of the shed, as the source for the transverse yarns. A “rapier” is used to pull these yarns through the shed. A “double rapier” has two rapiers, one which inserts ‘the yarn from one side to the midpoint of the shed, and another which picks up the yarn from the first rapier and pulls the yarn completely through the shed. As ‘each transverse yarn is pulled through the shed, its end is cut and the new end is grabbed by the rapier for the next insertion. To form the shed, the warp yarns are inserted into a metal wire or strip, called the “heddle”, which is raised and lowered electromechanically. All fabric weaving was performed using a Domier (Charlotte, N.C.) double rapier loom.

3.1 Inclusion of Optical Fiber into Fiberglass Yarn Prior to Weaving:

This is described in the concurrently filed application, “AN AUTOMATED PROCESS FOR EMBEDDING OPTICAL FIBERS IN FIBERGLASS YARNS” based on provisional application Ser. No. 60/734,849, all of the details of which are incorporated herein by reference thereto.

This optical yarn was then incorporated into a standard plain weave, 0.814 kg/m² fabric with a 5×4 construction. E-glass was used for all of the conventional yarns. Optical yarns were only included in the weft direction, via a conventional rapier operation. Because the optical yarn was multi-ended, it tended to splay and separate. This behavior required the use of slower acting machinery and special handling equipment to enable high quality fabric production. We would expect that many of these difficulties could have been avoided by using a single-ended optical yarn, although construction of such a yarn would have likely required inclusion of the yarn immediately after filament formation from the bushing. A total of 4.572 m of 2.032 m wide fabric was produced according to this method. We will call this fabric the “optical yarn fabric.”

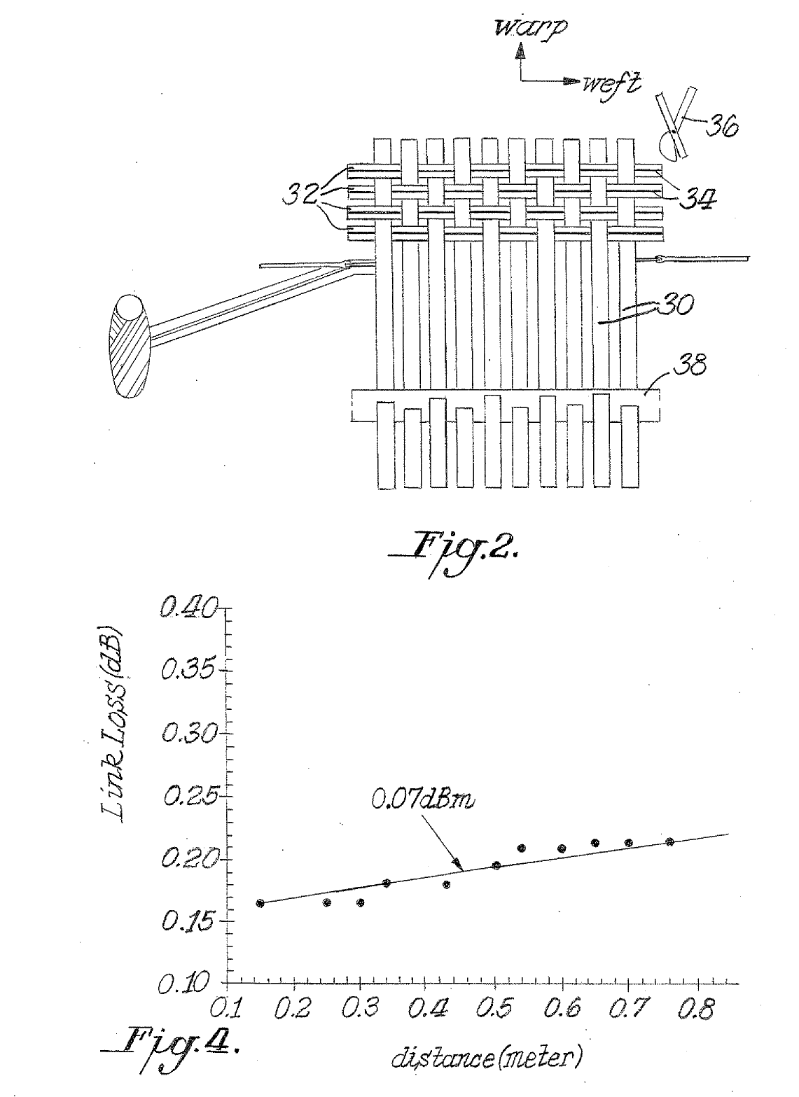

A schematic of the fabrication process for the optical yarn fabric is shown in FIG. 2. FIG. 2 illustrates, in general, the rapier used in the process. The warp yarns 30 and the weft yarns 32 are also illustrated. Each yarn includes a single optical fiber 34. FIG. 2 also schematically illustrates the location of a cutter 36 and the heddle wire 38.

3.2 Direct Insertion of Optical Fiber into Fabric During Weaving

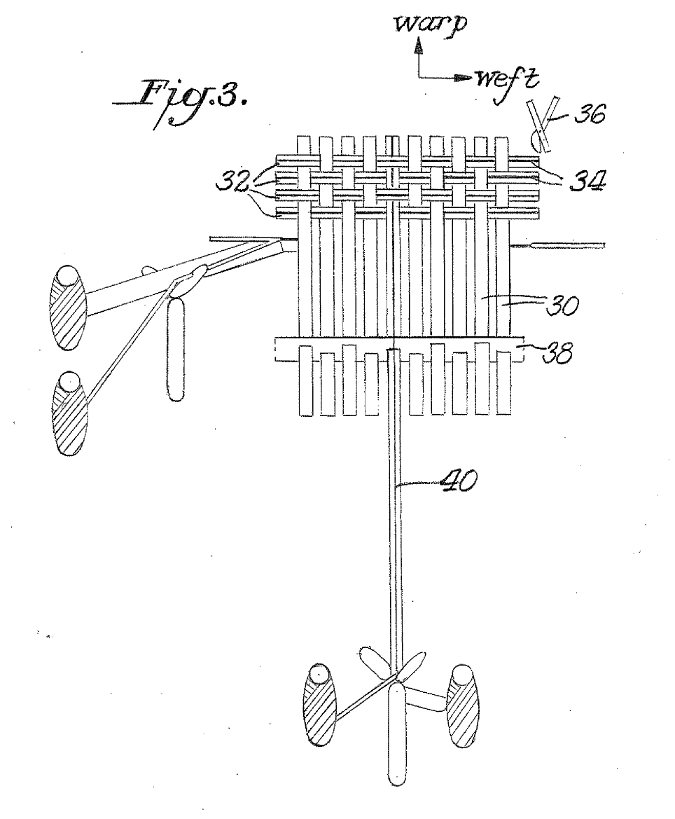

To reduce the number of fabrication steps, fabric was also produced by directly using an optical fiber spool as part of the fabric weaving process. As shown in FIG. 3 for warp-direction insertions, the optical fiber 40 was directly inserted into a single-ended warp-direction yarn 30 as it entered the heddle 38. Special handling hardware was used to ensure proper commingling of the optical fiber with the yarn. For weft-direction insertions, a special clamping mechanism was used to simultaneously grab and insert both the glass fiber yarn and the optical fiber.

In general, the warp direction optical fiber insertion was easier than weft insertion. The warp yarn 30 and optical fiber 40 are simply pulled under constant tension, in a relatively straight path, through the loom. In contrast, the weft direction yarns need to be grabbed, pulled, and cut with each insertion, which adds considerable complication to the process. However, using programmable looms, the optical fiber 34 can be added to specific weft yarn positions as needed. This feature provides a high degree of design flexibility, which enables tailoring of specific optical fiber insertion densities.

For our experiments, optical fiber was inserted into one-seventh of the warp yarns and into all of the weft direction yarns. A total of 4.572 m of 2.032 m wide fabric was produced according to this method, at a fabrication rate of 0.038 m/sec. FIG. 3 shows the schematic for this “direct optical fabric” fabrication process.

4.Optical Transmission Measurements

4.1 Optical Yarn

The complete 1 km optical yarn spool was connectorized at its ends and measured for transmissivity. Initial measurements showed no transmissivity, indicating a break in the optical fiber. However, after removing 3.048 in from one end of the yarn, and reconnectorizing, transmission through the spool with 0.04 dB loss was demonstrated. It is likely that a certain portion of this loss is associated with the curvature of the fiber, which was wound on a˜7.5 cm spool during transmission measurements,

4.1 Optical Yarn Fabric

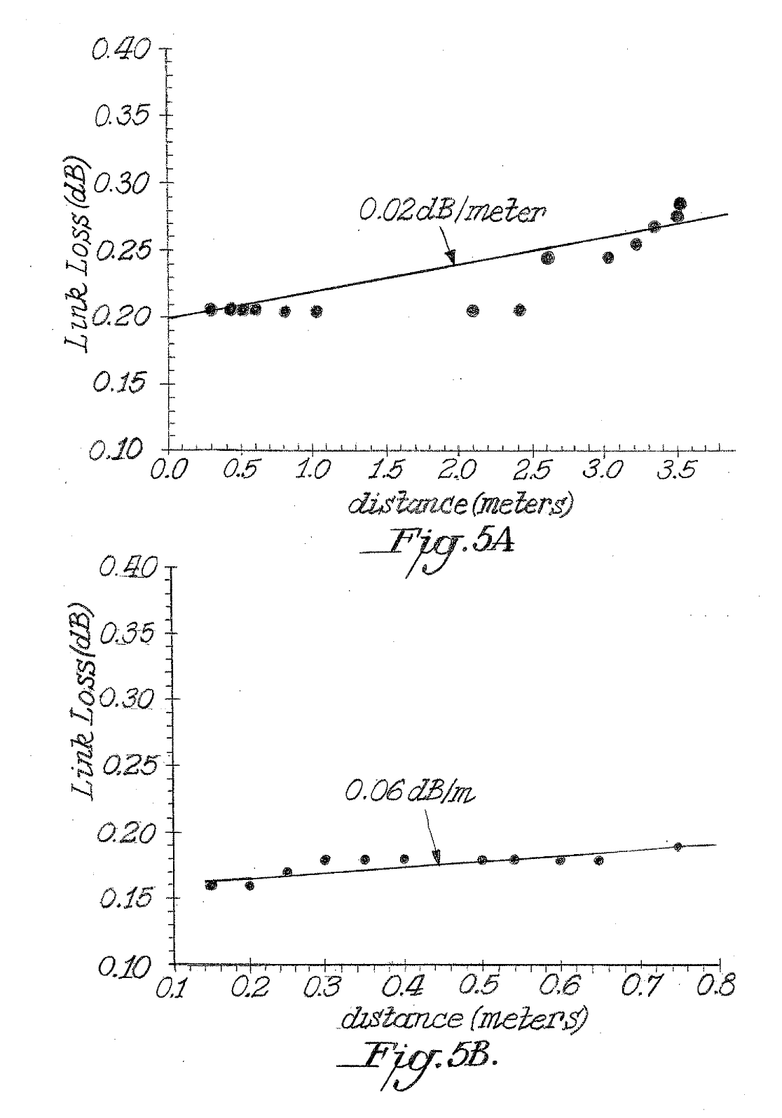

FIG. 4 shows optical loss as a function of length for weft-direction yarns in the optical yarn fabric. The resulting linear loss is approximately 0.07 dB/m. It is not drawn what fraction of these losses are associated with connectorization.

4.2 Direct Optical Fabric

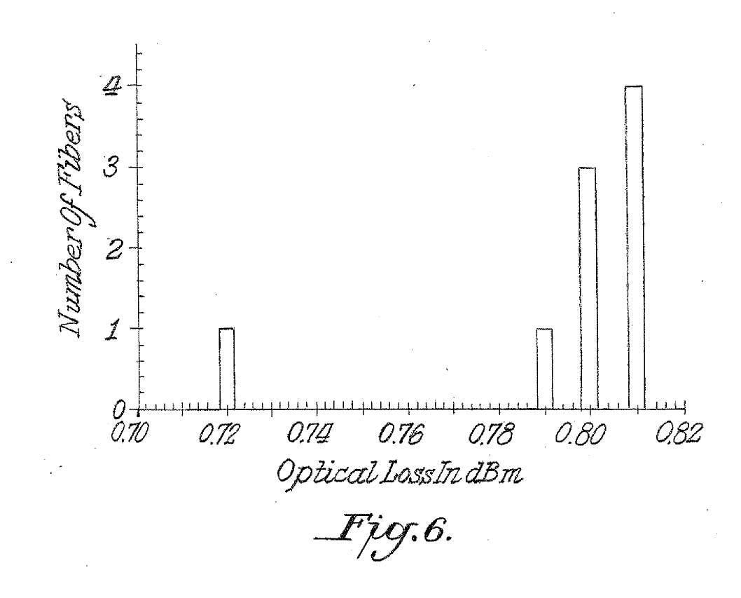

To isolate linear optical loss from connectorization losses., a series of transmission measurements were performed on various lengths of the direct optical fabric, in both the warp and well directions. FIGS. 5 (a) and (b) show the loss vs. optical fiber length for each of these cases. The y-intercept of the graphs represents the connectorization losses, while the slope of the graph indicates the loss per unit fiber length. These losses were found to be 0.02 dB/m and 0.06 dB/m for the warp and weft directions, respectively. The higher loss in the weft direction is reasonable, since the weaving process introduces more curvature into the weft yarns than into the warp yarns. This curvature can be crudely estimated using a set of calipers, and was found to be ˜0.007 m, ˜0.005 m in the weft and warp directions, respectively. These curvature-dependent losses in woven fabrics were also observed by Schuster et al. [11]. Based on the y-intercept of FIGS. 4 and 5, the connectorization losses are 0.1 dB per connector.

4.3 Composite with Direct Optical Fabric Preform

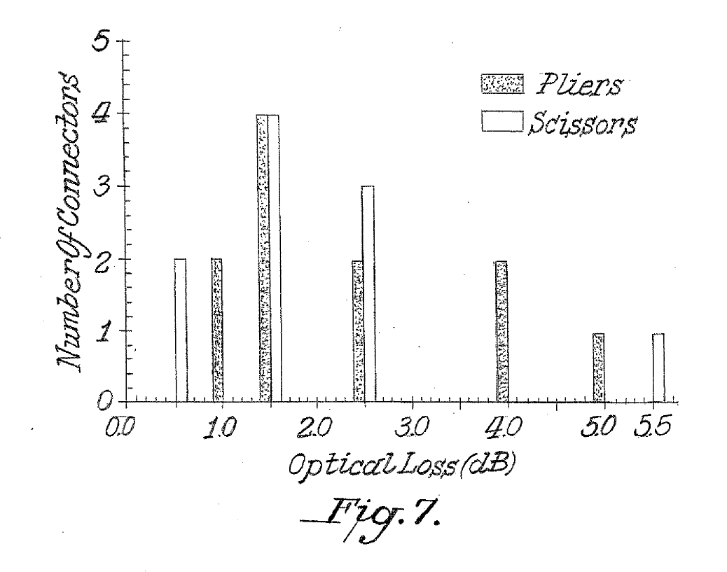

The direct optical fabric was used to create a composite material, as described in Section 3. After processing, the exposed optical fibers were connectorized and tested in transmission. A total of 9 fibers in the weft direction were connectorized, each with an effective length of 0.4 m. FIG. 6 shows the measured losses, with an average loss of 0.8 dB. For the direct optical preform, weft direction, the measured loss for a length of 0.4 m was 0.18 dB.

Therefore the composite fabrication process introduced an additional ˜0.6 dB loss. A majority of this additional loss is likely due to a sharp bend in the optical fiber at the edge of the part. This bending could have been significantly reduced through more careful fixturing of the optical fiber during composite processing. To secure the egress points of the optical fiber from breaking during the processing, optical fibers were inserted in a plastic tubes and then processed.

5. Novel Connectorization

Conventional optical fiber connectorization involves inserting the optical fiber into a ferrule, bonding the optical fiber in place, and then cleaving the fiber and polishing its tip. This process is time consuming and requires specialized skills and equipment, but is necessary to minimize connector optical losses. For structural composites with integrated optical fibers, these fixturing and polishing steps will likely add significant cost and time to the manufacturing process. Furthermore, typical polishing equipment requires significant optical fiber lengths in order to properly fixture the ferrule. This extra length could increase the likelihood of optical fiber failure during handling.

In all of the optical transmission measurements in Section 4, commercial non-polishing connectors were used. While the non-polishing aspect of these connectors greatly simplifies connectorization their bulky size (roughly 4×4×35 millimeter) adds a significant packaging burden to the structural composite.

Ideally, the optical fibers would be connected with a non-bulky connector which requires no polishing. To demonstrate such a connector, optical fibers were cut using two simple, conventional tools: scissors (shearing blades) or cutting pliers (clamping blades). The cut fibers were then inserted into stand-alone metal ferrules 2 mm in diameter×10 mm long (Part# F1-0061F, FiberlnstrumentSales [Oriskany, NW]). The ferrules were sized to accept the optical fiber with the plastic coating intact. A microscope slide was used as a mechanical stop to ensure that the cut face of the fiber was relatively flush with the ferrule. Once in place, the optical fiber was bonded to the ferrule using epoxy adhesive at the rear of the ferrule. Note that the plastic coating is not removed during this process.

To measure the connectivity losses for this technique, 21 sets of connectorized optical fibers were made. Ten of the fibers were cut using scissors, while the remainder were cut using cutting pliers. These novel connectors were used on both sides of the optical fiber. All measurements were made with a fiber length of 0.12 m. FIG. 7 shows the resulting plot of connector losses. The average loss for the scissors and pliers were 2.0 and 2.4 dB, respectively. Note that the losses for the non-polishing connectors in Section 4 were estimated to be 0.1 dB. These higher losses in the new connectors are likely due to a combination of misalignment of the optical fiber within the ferrule, and the roughness of the face of the optical fiber.

6. Discussion and Conclusions

The fabric weaving results show that optical fibers can be integrated into conventional glass fabric at commercially viable production rates, and without significant process modifications. The most efficient and flexible method of optical fiber introduction appears to be direct insertion of the optical fiber during the weaving process, rather than integration of the optical fiber into a multi-ended yarn prior to weaving. Both approaches, however, are gentle enough so that the optical fiber is not damaged during the weaving process.

Using these optical preforms, it is possible to create a polymer-matrix composite laminate using a conventional VARTM fabrication approach. The losses in this composite are only slightly higher than in the original preform, and are likely due to fiber ingress/egress effects which could be eliminated through more careful processing.

A connectorization technique has been demonstrated which produces acceptably low optical losses, without polishing. This technique could likely be automated, so that the total cost of integration and connectorization of optical fibers into a composite could be relatively low.

The approach presented here is limited by the need to fix the location of the optical fibers in the fabric during weaving, with only straight, warp-direction or weft-direction pathways possible. This constraint could limit the general applicability of these integrated waveguides in complex parts, or require custom fabric production for each composite component design. Additional work is also needed in the optical fiber connectorization. Although our connectorization method is relatively simple, the optical fiber “pigtail” which extends from the part is very fragile. More robust means of optical signal ingress/egress to/from the embedded optical fiber are needed.

### REFERENCES

1. M. Studer, K. Peters, and J. Botsis, Proceedings of SPIE The International Society for Optical Engineering, 4694, 94 (2002).
2. P. S. Uskokovic, I. Balac, M. Rakin, S. Putic, M. Sreckovic and R. Aleksic, Materials Science Forum 352, 177 (2000).
3. W. Chen, Y. Zhu, Y. Fu, J. Feng and S. Huang, Proceedmnns of SPIE 4222., 16(2000).
4. P. Masson and A. M. Berry, Journal of Intelliuent Material Systems and Structures, 10, 71(2000).
5. Y. N. Kulchin, O. B. Vitrik and C. P. Khomentovskiy, Proceedings of SPIE. The International Society for Optical Engineering, 5129, 31(2002).
6. R. Huang, S. Yuan and B. Tao, Proceedings of SPIIE. The International Society for Optical Engineering 4221,389 (2000).
7. ______ C. C. Chang and J. Sirkis, Journal of Intellinent Material Systems and Structures 8 829(1997)
8. W. P. Wang, T. H. Hwang, E. Y. Shu, M. H. Vartanian and R. A. Ridilla, Applied Composite Materials, 4,187(1997).
9. W. Du, X. M. Tao, R Y. Tam and C. L. Choy, Composite Structures 42 2 17(1998).
10. J. Schuster, M. Trahan, D. Heider and W. Li, Composites Part A: Applied Science and Manufacturin2, 34, 855 (2003).
11. A. E. Bogdanovich and D. E. Wigent, ˜˜EJ %, 39,6(2003).
12. S. G. Advani and E. M. Sozer, Process Modeling in Composites Manufacturin2, Marcel Dekker, New York, 2002.

What is claimed is:

1. In a method for integrating optical fiber into composite structural materials the improvement being in that the fiber is introduced in an automated fashion into composite structural materials which include a woven fabric as one of the components.

2. The method of claim 1 wherein the woven fabric is embedded in resin using a vacuum infusion process to create a structural composite with integrated optical conduit with less than 0.8413 optical loss.

3. The method of claim 2 wherein the optical fibers are embedded in the woven fabric in both warp and weft directions.

4. The method of claim 1 wherein the optical fiber connectorization is done without polishing.

5. The method of claim 1 wherein the woven fabric is of a textile material.

6. The method of claim 1 wherein the woven fabric is armor related fabric.

7. The method of claim 1 wherein the method includes the use of weaving machinery and the optical fiber being in a spool in the weaving machine.

8. The method of claim 7 wherein the optical fiber is introduced by direct insertion during the weaving process.
